(19) United States
(12) Patent Application Publication
(10) Pub. No.: US 2025/0192319 A1
(43) Pub. Date: Jun. 12, 2025

(54) BATTERY PACK FOR A VEHICLE

(71) Applicants: HYUNDAI MOTOR COMPANY, Seoul (KR); KIA CORPORATION, Seoul (KR)

(72) Inventor: Kyung Mo Kim, Hwaseong-si (KR)

(73) Assignees: HYUNDAI MOTOR COMPANY, Seoul (KR); KIA CORPORATION, Seoul (KR)

(21) Appl. No.: 18/655,967

(22) Filed: May 6, 2024

(30) Foreign Application Priority Data
Dec. 8, 2023 (KR) 10-2023-0177702

(51) Int. Cl. H01M 50/264; H01M 50/249; H01M 50/505; H01M 50/555

(52) U.S. Cl. CPC H01M 50/264; H01M 50/249; H01M 50/505; H01M 50/555

(57) ABSTRACT

A battery pack for a vehicle includes: a lower casing forming a bottom and lateral sides of the battery pack; a plurality of battery modules accommodated in the lower casing; a displacement fastening mechanism fastening a first side of the battery modules to the lower casing by moving the battery modules relative to the lower casing; and a fastening mechanism securing a busbar between the battery module and an adjacent battery module of the plurality of battery modules while fastening a second side of the battery module to the lower casing.

### CROSS REFERENCE TO RELATED APPLICATION

The present application claims priority to Korean Patent Application No. 10-2023-0177702, filed Dec. 8, 2023, the entire contents of which are incorporated herein for all purposes by this reference.

### BACKGROUND

### Field of the Disclosure

The present disclosure relates to a battery pack mounted to a vehicle.

### Description of the Related Art

An electric vehicle or the like is mounted with a battery pack to supply power to a motor that drives the vehicle.

The battery pack accommodates a plurality of battery modules therein. A battery module includes a plurality of battery cells.

The plurality of battery modules accommodated in the battery pack is required to be not only firmly fastened but also securely electrically connected through a busbar or the like.

The information described as the related art is merely intended to aid in understanding the background of the present disclosure. Therefore, the above information should not be accepted as recognition of the prior art that has already been known to a person having ordinary knowledge in the art.

### SUMMARY

An aspect of the present disclosure is to provide a battery pack for a vehicle that ensures that battery modules are firmly and stably fastened and electrically connected. Another aspect of the present disclosure is to ensure that the battery modules are easily assembled, and have decreased weight with a simple structure, thereby ultimately reducing manufacturing costs and enhancing quality.

According to an embodiment of the present disclosure, a battery pack for a vehicle includes a lower casing forming a bottom and lateral sides of the battery pack and a plurality of battery modules accommodated in the lower casing. The battery pack further includes a displacement fastening mechanism fastening a first side of the battery modules to the lower casing by moving the battery modules relative to the lower casing. Additionally, the battery pack includes a fastening mechanism securing busbars between battery modules while fastening a second side of the battery modules to the lower casing. The first side of the battery modules is fastened by the displacement fastening mechanism to the lower casing.

The displacement fastening mechanism may include one or more latches elastically protruding laterally from the first side of the battery modules. Additionally, the displacement fastening mechanism may include one or more hook projections provided on a lateral wall of the lower casing so that the latches can be elastically locked to the hook projections by moving downward relative to the lower casing and then being restricted from moving upward.

Each latch may have an elastic plate shape and may protrude laterally toward an upper side of the battery modules.

Each hook projection may include a holding supporter provided on the lateral wall of the lower casing to hold an upper end of the respective latch and may include an insertion limit portion formed in a lower side of the holding supporter to limit a lateral insertion depth of the latch.

Each hook projection may further include an inclined guide portion provided on an upper side of the holding supporter and protruding obliquely downward from the lateral wall of the lower casing to allow the respective latch to move downward. The inclined guide portion may include a tool insertion portion configured to allow a tool to be inserted therein to release the respective latch from a locked state by elastically transforming the latch held in the holding supporter and the insertion limit portion.

Each insertion limit portion may include a gap forming groove so that the tool can be inserted between the insertion limit portion and the latch.

The fastening mechanism may include an inner member fixed in the lower casing and a fastening bolt fastening a battery module to the inner member while penetrating both an electrode terminal of the battery module and the busbar.

The battery module may be provided integrally with a fixing flange penetrated along with the electrode terminal by the fastening bolt to fix the battery module in the inner member.

The fixing flange may support a bottom surface of the electrode terminal.

The inner member may be provided with a fastening nut to which the fastening bolt is fastened. Additionally, the fastening nut may be electrically insulated from the inner member.

The battery pack may further include an insulating block fixed and coupled to the inner member. The insulating block may surround the fastening nut to electrically insulate the fastening nut from the inner member.

A block insertion portion, in which the insulating block is inserted, may be provided on a top surface of the inner member. The block insertion portion may be a hole having a polygonal shape to prevent the insulating block from rotating along with rotation of the fastening bolt. The insulating block may be shaped to correspond with the polygonal shape of the hole of the block insertion portion and prevented from rotating.

The insulating block may be provided integrally with an elastic branch. The elastic branch may elastically prevent the insulating block from moving upward through the block insertion portion when the insulating block is inserted in the inner member through the block insertion portion.

The battery pack may further include a fixing pin fastened and penetrating the inner member and the insulating block to fix the insulating block inserted in the inner member.

The fixing pin may penetrate and fasten a plurality of insulating blocks inserted in the inner member.

The inner member may be provided at a center of the lower casing in a lengthwise or front to rear direction of the battery pack. The battery modules may be symmetrically arranged on opposite sides of the inner member so that the electrode terminal and the fixing flange of each battery module faces the inner member. Latches of each of the battery modules may be held in corresponding hook projections provided on both lateral walls of the lower casing.

According to an embodiment of the disclosure, a battery module includes a latch provided at a first side of the battery module and configured to be fastened to a lower casing of a battery pack by moving relative to the lower casing. The battery module also includes an electrode terminal provided at a second side of the battery module and configured to be fastened to an inner member provided in the lower casing while being electrically insulated from the inner member.

The latch may have an elastic plate shape and may protrude laterally toward an upper side of the battery module.

The electrode terminal may be formed to be penetrated by a fastening bolt fastened to the inner member. A fixing flange may be integrally provided on a bottom of the electrode terminal and configured to be penetrated along with the electrode terminal by the fastening bolt to fix the battery module to the inner member.

According to the present disclosure, a battery pack for a vehicle is provided. The battery pack ensures that battery modules are firmly and stably fastened and electrically connected. Additionally, the battery pack is easily assembled, and has a decreased weight with a simple structure, thereby ultimately reducing manufacturing costs and enhancing quality.

### BRIEF DESCRIPTION OF THE DRAWINGS

FIG. 1 illustrates a structure of a battery pack according to the disclosure.

FIG. 2 illustrates an assembled state of the battery pack components of FIG. 1.

FIG. 3 illustrates a battery module of the battery pack of FIG. 1 in detail.

FIG. 4 illustrates a latch of the battery module of FIG. 3.

FIG. 5 is a view illustrating a hook projection provided on a lateral wall of a lower casing.

FIG. 6 illustrates that a latch locked to a hook projection is released.

FIG. 7 illustrates a process of mounting a battery module to a lower casing.

FIG. 8 illustrates a fixed state of the battery module mounted to the lower casing by the process of FIG. 7.

FIG. 9 is a plan view of the battery pack in FIG. 2.

FIG. 10 shows the feature in circle F10 of FIG. 9 viewed from a lateral direction.

FIG. 11 illustrates a state in which the battery module on the right side in FIG. 10 is removed.

FIG. 12 illustrates an inner member of the battery pack in FIG. 10.

FIG. 13 illustrates an insulating block and a fastening nut in FIG. 10.

FIG. 14 is a cross-sectional view taken along line F14-F14 of the battery pack in FIG. 9.

### DETAILED DESCRIPTION

Hereinafter, embodiments of the present disclosure are described in detail with reference to the accompanying drawings, in which the same or similar elements are denoted by the same reference numerals even though they are depicted in different drawings. Redundant descriptions thereof have been omitted.

Suffixes such as “module” and “unit” in the following description are given in consideration to ease understanding of the description and do not have meaning or functions discriminated from each other.

In terms of describing the embodiments of the present disclosure, detailed descriptions of related art have been omitted where they made the subject matter of the embodiments of the present disclosure rather unclear. In addition, the accompanying drawings are provided only for a better understanding of the embodiments of the present disclosure and are not intended to limit the technical ideas of the disclosure. Therefore, it should be understood that the accompanying drawings include all modifications, equivalents, and substitutions within the scope and sprit of the present disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to the other component, but additional components may be present therebetween. However, when one component is described as being “directly connected,” or “directly coupled” to another component, it should be understood that additional components may be absent between the one component and the other component.

Unless the context clearly dictates otherwise, singular forms include plural forms as well.

In the disclosure, it should be understood that terms such as “include”, “comprise”, or “have” and variations thereof indicate that a feature, a number, a step, an operation, an element, a part, or a combination thereof described in the embodiments is present. However, such terms do not preclude a possibility of presence or addition of one or more other features, numbers, steps, operations, elements, parts or combinations thereof, in advance.

When a component, device, element, or the like of the present disclosure is described as having a purpose or performing an operation, function, or the like, the component, device, or element should be considered herein as being “configured to” meet that purpose or to perform that operation or function.

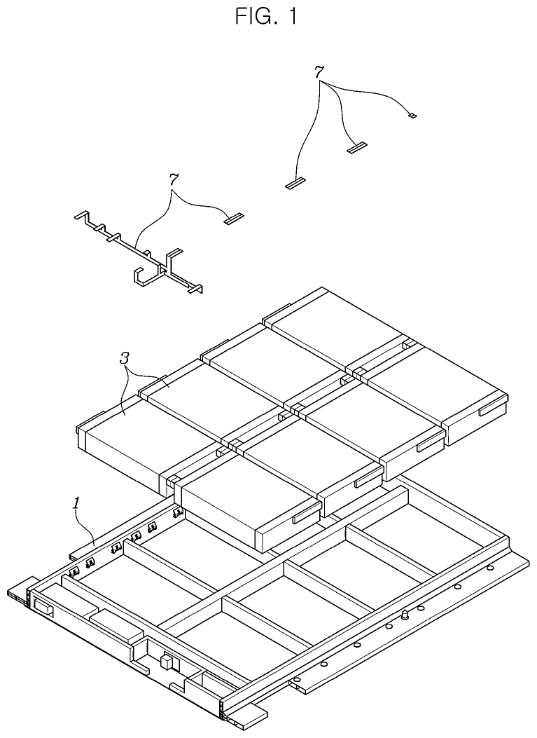

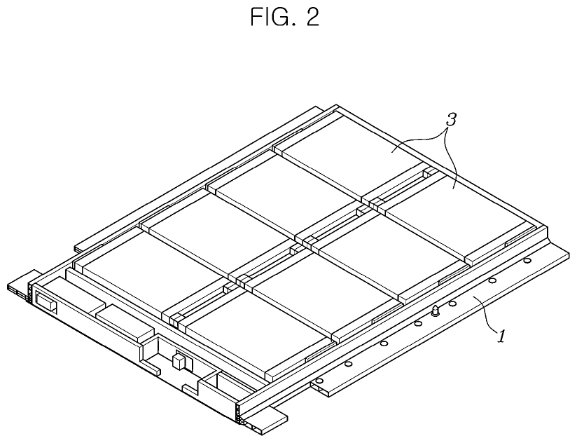

Referring to FIGS. 1-14, a battery pack for a vehicle according to an embodiment of the present disclosure includes a lower casing 1 forming the bottom and lateral sides of the battery pack. The battery pack also has a plurality of battery modules 3 accommodated in the lower casing 1. The battery pack also includes a displacement fastening mechanism 5 fastening a first side of a battery module 3 of the plurality of battery modules 3 to the lower casing 1 by moving the battery module 3 relative to the lower casing 1. The battery back also includes a fastening mechanism 9 securing a busbar 7 between the battery module 3 and another adjacent battery module 3 of the plurality of battery modules while fastening a second side of the battery module 3 to the lower casing 1. The first side of the battery module is fastened by the displacement fastening mechanism 5 to the lower casing 1.

In other words, the battery pack of the present disclosure is quickly and easily assembled, and the battery pack's weight is reduced by minimizing the number of necessary parts. This is achieved by having both the electric connection and the firm lock of the battery modules 3 completed as the first sides of the plurality of battery modules 3 accommodated in the lower casing 1 are naturally fastened by the displacement fastening mechanism 5 and the second sides of the plurality of battery modules 3 are fastened to the lower casing 1 together with the busbars 7 by the fastening mechanism 9. As a result, manufacturing costs are significantly reduced.

For reference, a separate upper cover (not shown) may be coupled to an upper side of the lower casing 1 after the battery modules 3, the busbars 7, and the like parts are accommodated in the lower casing 1. As a result, the separate upper cover ensures the watertightness for the battery modules 3 and the parts. Herein, details of one battery module 3 or two adjacent battery modules 3 are described and those details may be equally applicable to all of the battery modules 3 of the battery pack.

The displacement fastening mechanism 5 includes a latch 11 elastically protruding laterally from a first side of a battery module 3. Additionally, the displacement fastening mechanism 5 includes a respective hook projection 13 provided on a lateral wall of the lower casing 1 so that the latch 11 can be elastically locked to the respective hook projection 13 by moving downward relative to the lower casing 1 and then restricted from moving upward. Each battery module 3 may include one or more of the latches 11 and thus the lateral wall of the lower casing 1 may include a corresponding number of the hook projections 13. A displacement fastening mechanism 5 may be defined as including one latch 11 and one hook projection 13 such that the battery pack includes numerous mechanisms 5. Alternatively, a displacement fastening mechanism 5 may be defined as including each latch 11 and hook projection 13 on one battery module 3 or as including all of the latches 11 and hook projections 13 of the entire battery pack.

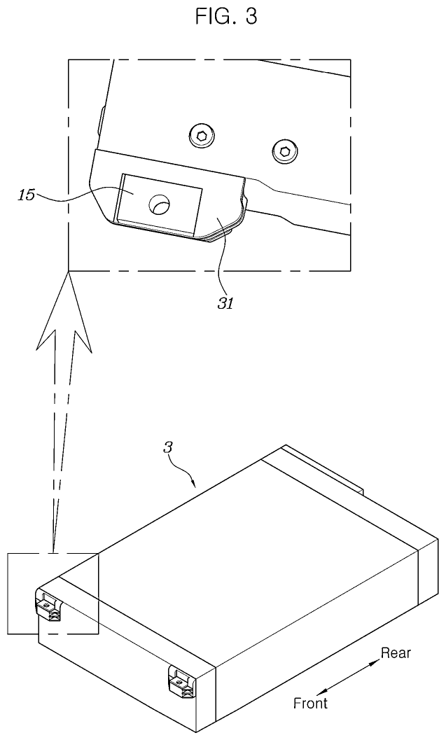

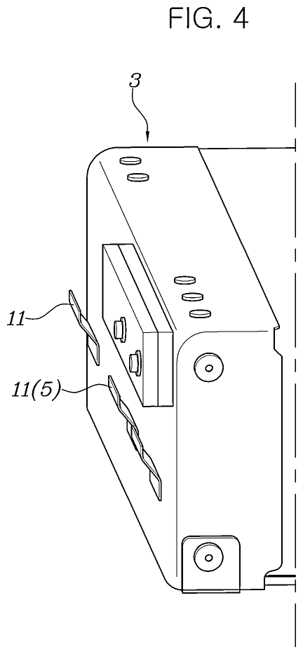

For reference, in FIGS. 3 and 4, the first side and second side of the battery module 3 should be understood as a rear side and a front side, respectively. In other words, in FIGS. 3 and 4, the latch 11 is provided on the rear side of the battery module 3 and an electrode terminal 15 is provided on the front side of the battery module 3.

In this embodiment, the latch 11 is provided as an elastic plate or as having an elastic plate shape protruding laterally toward the upper side of the rear side of the battery module 3.

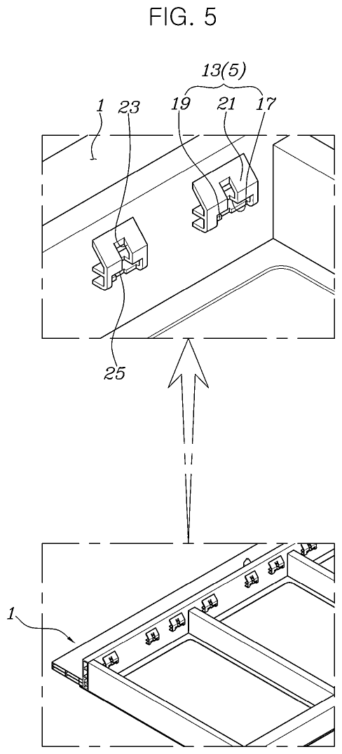

The hook projection 13, as shown in FIG. 5, includes a holding supporter 17 provided on the lateral wall of the lower casing 1 to hold an upper end of the latch 11. The hook projection 13 also includes an insertion limit portion 19 formed in a lower side of the holding supporter 17 to limit a laterally inserted depth of the latch 11.

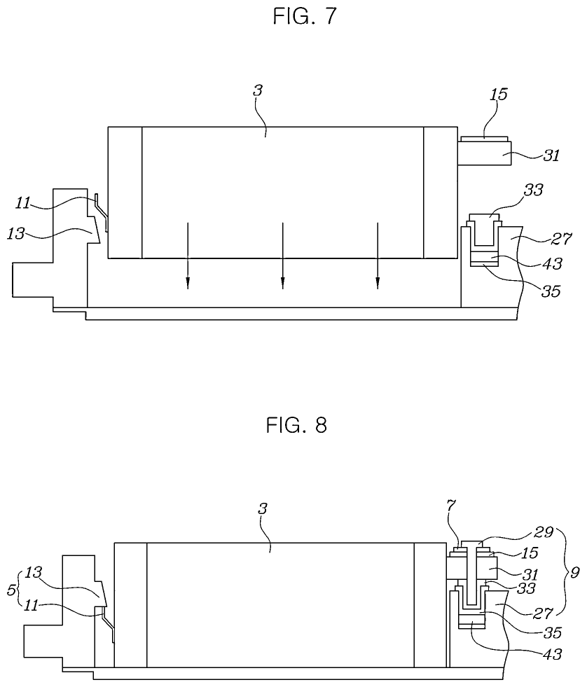

Therefore, when the battery module 3 relatively moves downward from the upper side of the lower casing 1 as shown in FIG. 7, the latch 11 is elastically transformed (e.g., bent or deformed) to be held by the holding supporter 17 and the insertion limit portion 19 of the hook projection 13 as shown in FIG. 8. As a result, the configuration secures the first side of the battery module 3 to the lower casing 1.

The hook projection 13 further includes an inclined guide portion 21 provided on an upper side of the holding supporter 17 and protruding obliquely downward from the lateral wall of the lower casing 1 to allow the latch 11 to move downward. Additionally, a tool insertion portion 23 is provided in the inclined guide portion 21. The tool insertion portion 23 allows a tool T to be inserted therein to release the latch 11 from the locked state by elastically transforming the latch 11 held in the holding supporter 17 and the insertion limit portion 19.

Further, the insertion limit portion 19 is formed with a gap forming groove 25 so that the tool T can be inserted between the insertion limit portion 19 and the latch 11.

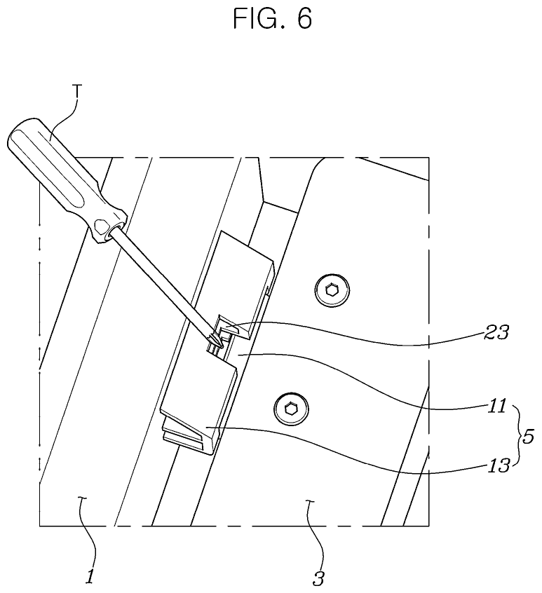

Therefore, as shown in FIG. 6, the tool T is inserted in the gap forming groove 25 through the tool insertion portion 23 to elastically transform the latch 11. The latch 11 locked to the hook projection 13 is thereby released so that the battery module 3 can be separated from the lower casing 1.

Such a structure provides easy maintenance for the battery pack and the battery module 3.

The fastening mechanism 9 according to an embodiment includes an inner member 27 fixed in the lower casing 1. Additionally, the fastening mechanism 9 includes a fastening bolt 29 fastening the battery module 3 to the inner member 27 while penetrating both the electrode terminal 15 of the battery module 3 and the busbar 7.

In other words, as shown in FIG. 8, the opposite side of the battery module 3 secured by the latch 11 is fastened to the inner member 27 by the fastening bolt 29. As a result, the battery module 3 is firmly fixed in the lower casing 1.

According to an embodiment, the battery module 3 is provided integrally with a fixing flange 31 that is penetrated along with the electrode terminal 15 by the fastening bolt 29 and fixing the battery module 3 in the inner member 27.

The fixing flange 31 protrudes outward from the lateral side of the battery module and supports the bottom surface of the electrode terminal 15.

Therefore, the fixing flange 31 is interposed between the electrode terminal 15 and the inner member 27 and is compressed by the fastening bolt 29. As a result, the fixing flange functions as electrical insulation between the electrode terminal 15 and the inner member 27 as well as firmly fixing the battery module 3.

The fixing flange 31 may be formed integrally with a module cover or the like of the battery module 3. The fixing flange 31 may be shaped to entirely surround the bottom surface and periphery of the electrode terminal 15, except the top surface that comes into contact with the busbars 7. As a result, the fixing flange 31 prevents unnecessary electrical exposure of the electrode terminal 15.

The inner member 27 is provided with a fastening nut 33 to which the fastening bolt 29 is fastened. The fastening nut 33 is electrically insulated from the inner member 27.

In other words, according to an embodiment, an insulating block 35 is fixed and coupled to the inner member 27 while surrounding the fastening nut 33 to be electrically insulated from the inner member 27.

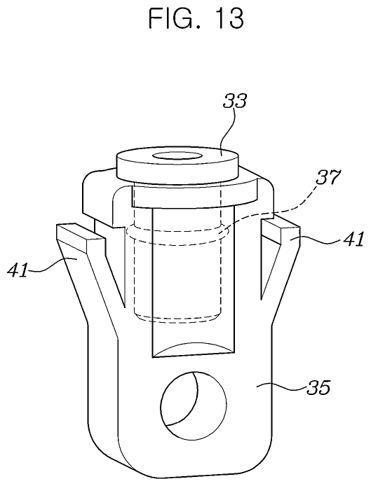

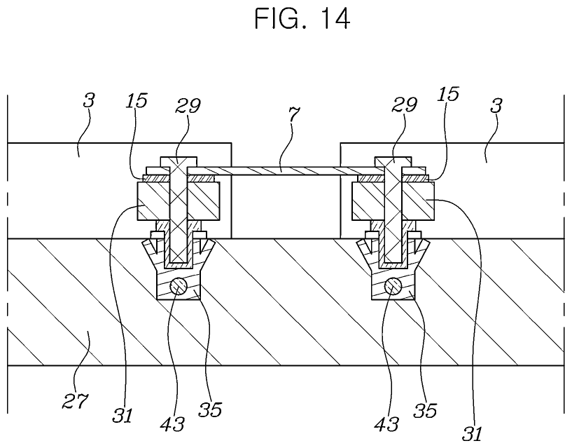

The fastening nut 33 may be integrally formed in and coupled to the insulating block 35 by insert injection or the like. As shown in FIG. 13, the fastening nut 33 is formed with a locking end 37 on the outer circumferential surface thereof, and thus prevented from falling out of the insulating block 35 to maintain a firm coupling structure even though it is strongly fastened to the fastening bolt 29.

A block insertion portion 39, in which the insulating block 35 is inserted, is provided on a top surface of the inner member 27. The block insertion portion 39 is a hole that has a polygonal shape to prevent the insulating block 35 from rotating along with the rotation of the fastening bolt 29. The insulating block 35 is thus shaped to correspond with the polygonal shape of the hole and is inserted in the polygonal hole of the block insertion portion 39 and prevented from rotating.

Therefore, even though the rotational force of the fastening bolt 29 is transferred to the insulating block 35 via the fastening nut 33, the inner member 27 effectively restrains the rotation of the insulating block 35 and firmly maintains the rotation restraint state.

The insulating block 35 is provided integrally with one or more elastic branches 41, i.e., flexible legs or fingers. The elastic branches 41 are elastically transformed to prevent the insulating block 35, which has been moved down and inserted in the inner member 27 through the block insertion portion 39, from moving upward through the block insertion portion 39.

In other words, when the insulating block 35 is press-fitted from above into the block insertion portion 39 of the inner member 27, the elastic branches 41 of the insulating block 35 are elastically transformed so that the insulating block 35 can be inserted through the block insertion portion 39. Then, the elastic branches 41 are elastically opened after passing through the block insertion portion 39, thereby preventing the insulating block 35 from falling out of the inner member 27.

In addition, a fixing pin 43 penetrates and fastens the inner member 27 and the insulating block 35 to further fix the insulating block 35 inserted in the inner member 27.

The fixing pin 43 may also function to prevent the separation of the insulating block 35 inserted in the inner member 27 and prevent the rotation of the insulating block 35.

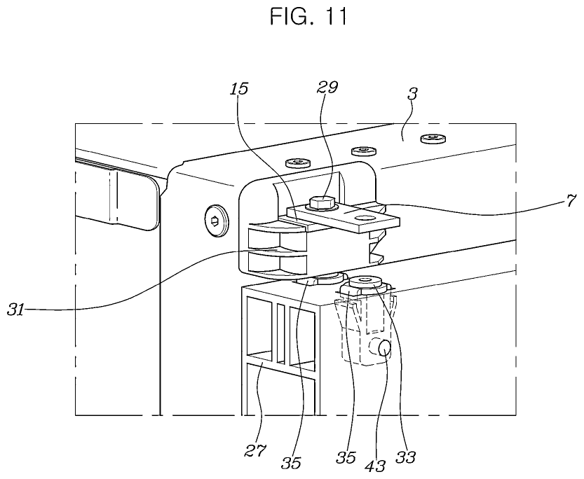

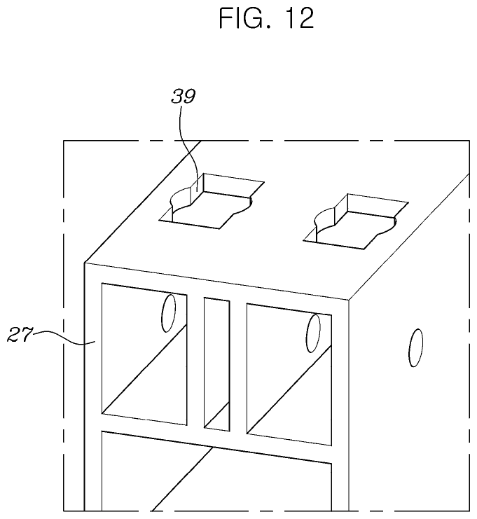

Further, as shown in FIG. 11, the fixing pin 43 is provided to penetrate and fasten a plurality of insulating blocks 35 inserted in the inner member 27 at once, thereby reducing the number of fixing pins 43 required.

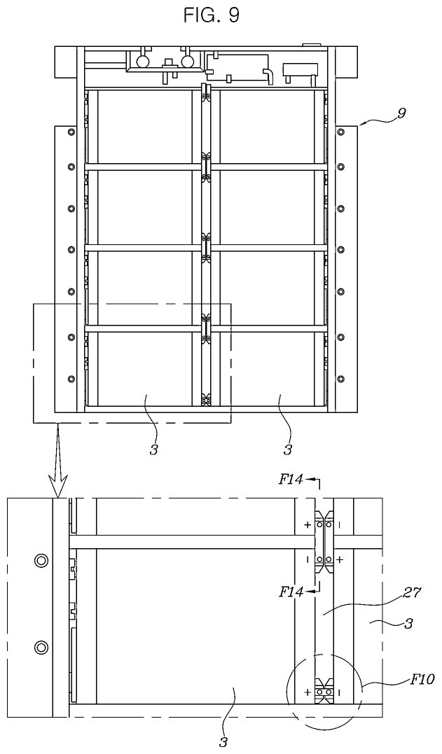

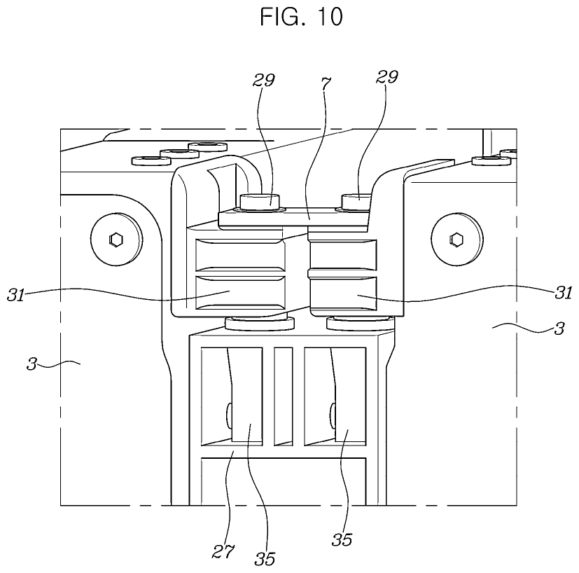

As shown in FIG. 9, according to an embodiment, the inner member 27 is provided at the center of the lower casing 1 in a lengthwise direction (e.g., a front to rear direction or longitudinal direction) of the battery pack. The battery modules 3 are symmetrically arranged on the opposite sides of the inner member 27 so that the electrode terminal 15 and the fixing flange 31 of each battery module can face the inner member 27. Respective latches 11 of the battery modules 3 are held in the corresponding hook projections 13 provided on both lateral walls of the lower casing 1.

Therefore, all operations for fixing the battery modules 3 accommodated in the lower casing 1 are substantially performed above the inner member 27 at the center of the lower casing 1. Additionally, all operations of fastening the battery modules 3 to the opposite lateral walls of the lower casing 1 are naturally carried out by the latches 11 and the hook projections 13. As a result, the configuration implements a simple and efficient assembly process for units of battery packs.

Although specific embodiments of the present disclosure have been illustrated and described as above, various modifications and changes can be made by a person having ordinary knowledge in the art without departing from the scope of technical ideas defined by the appended claims.

What is claimed is:

1. A battery pack for a vehicle, the battery pack comprising:
a lower casing forming a bottom and lateral sides of the battery pack;
a plurality of battery modules accommodated in the lower casing;
a displacement fastening mechanism fastening a first side of a battery module of the plurality of battery modules to the lower casing only by moving the battery module relative to the lower casing; and
a fastening mechanism securing a busbar between the battery module and an adjacent battery module of the plurality of battery modules while fastening a second side of the battery module to the lower casing.

2. The battery pack of claim 1, wherein the displacement fastening mechanism comprises:
a latch elastically protruding laterally from the first side of the battery module; and
a hook projection provided on a lateral wall of the lower casing so that the latch can be elastically locked to the hook projection by moving downward relative to the lower casing and then being restricted from moving upward.

3. The battery pack of claim 2, wherein the latch has an elastic plate shape and protrudes laterally toward an upper side of the first side of the battery module.

4. The battery pack of claim 3, wherein the hook projection comprises:
a holding supporter provided on the lateral wall of the lower casing holding an upper end of the latch; and
an insertion limit portion in a lower side of the holding supporter limiting a lateral insertion depth of the latch.

5. The battery pack of claim 4, wherein:
the hook projection further comprises an inclined guide portion provided on an upper side of the holding supporter and protruding obliquely downward from the lateral wall of the lower casing to allow the latch to move downward; and
the inclined guide portion comprises a tool insertion portion configured to allow a tool to be inserted therein to release the latch from a locked state by elastically transforming the latch held in the holding supporter and the insertion limit portion.

6. The battery pack of claim 5, wherein the insertion limit portion comprises a gap forming groove so that the tool can be inserted between the insertion limit portion and the latch.

7. The battery pack of claim 2, wherein the fastening mechanism comprises:
an inner member fixed in the lower casing; and
a fastening bolt fastening the battery module to the inner member while penetrating both an electrode terminal of the battery module and the busbar.

8. The battery pack of claim 7, wherein the battery module is provided integrally with a fixing flange that is penetrated along with the electrode terminal by the fastening bolt to fix the battery module in the inner member.

9. The battery pack of claim 8, wherein the fixing flange supports a bottom surface of the electrode terminal.

10. The battery pack of claim 7, wherein:
the inner member is provided with a fastening nut to which the fastening bolt is fastened; and
the fastening nut is electrically insulated from the inner member.

11. The battery pack of claim 10, further comprising an insulating block fixed and coupled to the inner member, wherein the insulating block surrounds the fastening nut to electrically insulate the fastening nut from the inner member.

12. The battery pack of claim 11, wherein:
a block insertion portion, in which the insulating block is inserted, is provided on a top surface of the inner member;
the block insertion portion is a hole having a polygonal shape to prevent the insulating block from rotating along with rotation of the fastening bolt; and
the insulating block is shaped to correspond with the polygonal shape of the hole and prevented from rotating.

13. The battery pack of claim 12, wherein:
the insulating block is provided integrally with an elastic branch; and
the elastic branch elastically prevents the insulating block from moving upward through the block insertion portion when the insulating block is inserted in the inner member through the block insertion portion.

14. The battery pack of claim 12, further comprising a fixing pin fastened penetrating the inner member and the insulating block to fix the insulating block inserted in the inner member.

15. The battery pack of claim 14, wherein the fixing pin penetrates and fastens a plurality of insulating blocks inserted in the inner member.

16. The battery pack of claim 8, wherein:
the inner member is provided at a center of the lower casing in a lengthwise direction of the battery pack;
the plurality of battery modules is symmetrically arranged on opposite sides of the inner member so that the electrode terminal and the fixing flange of each battery module of the plurality of battery modules face the inner member; and
latches of each of the plurality of battery modules are held in corresponding hook projections provided on both lateral walls of the lower casing.

17. A battery module comprising:
a latch provided at a first side of the battery module and configured to be fastened to a lower casing of a battery pack by moving relative to the lower casing; and
an electrode terminal provided at a second side of the battery module and configured to be fastened to an inner member provided in the lower casing while being electrically insulated from the inner member.

18. The battery module of claim 17, wherein the latch has an elastic plate shape and protrudes laterally toward an upper side of the battery module.

19. The battery module of claim 17, wherein:
the electrode terminal is formed to be penetrated by a fastening bolt fastened to the inner member; and
a fixing flange is integrally provided on a bottom of the electrode terminal and configured to be penetrated along with the electrode terminal by the fastening bolt to fix the battery module to the inner member.
